(19) United States
(12) Patent Application Publication
(10) Pub. No.: US 2022/0274493 A1
(43) Pub. Date: Sep. 1, 2022

(54) CONTAINER INTEGRATED BATTERY ASSEMBLY

(71) Applicant: ELECTRIC POWER SYSTEMS, INC., North Logan, UT (US)

(72) Inventor: Randy Dunn, Orange, CA (US)

(73) Assignee: ELECTRIC POWER SYSTEMS, INC., North Logan, UT (US)

(21) Appl. No.: 17/748,662

(22) Filed: May 19, 2022

Related U.S. Application Data
(63) Continuation of application No. PCT/US2020/059446, filed on Nov. 6, 2020.
(60) Provisional application No. 62/938,721, filed on Nov. 21, 2019.

(51) Int. Cl. B60L 53/00; H01M 10/46; H01M 10/052; H01M 10/42; B65D 88/14; B64D 27/24; B64C 39/02

(52) U.S. Cl. CPC B60L 53/00; H01M 10/46; H01M 10/052; H01M 10/4257; B65D 88/14; B64D 27/24; B64C 39/024; H01M 2010/4271; H01M 2220/10; H01M 2220/20; B60L 2200/10; B64C 2201/027; B64C 2201/128; B64C 2201/042

(57) ABSTRACT

An intermodal shipping system comprises a drone and a container. The drone comprises a drone battery and the container comprises a container battery. The container battery is configured to charge the drone battery during operation of the drone. The container battery is configured to charge while the container is idle. The container battery may be integral to the container or coupled to the container.

### CROSS-REFERENCE TO RELATED APPLICATIONS

This application is a continuation of, and claims priority to PCT Application Serial No. PCT/2020/059446 filed Nov. 6, 2020 titled “CONTAINER INTEGRATED BATTERY ASSEMBLY” (hereinafter '446 Application). The '446 Application claims priority to, and benefit of, U.S. Provisional Patent Application Ser. No. 62/938,721 filed on Nov. 21, 2019 titled “CONTAINER INTEGRATED BATTERY ASSEMBLY,” (hereinafter the '721 Application). The '446 Application and '721 Application are hereby incorporated by reference in their entirety.

### FIELD OF INVENTION

The present disclosure generally relates to apparatus, systems and methods for improved intermodal shipping; in particular, a container integrated battery assembly.

### BACKGROUND OF THE INVENTION

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may be inventions.

A battery module, for purposes of this disclosure, includes a plurality of electrically connected cell brick assemblies. These cell brick assemblies may, in turn, include a parallel, series, or combination of both, collection of electrochemical or electrostatic cells hereafter referred to collectively as “cells”, that can be charged electrically to provide a static potential for power or released electrical charge when needed. When cells are assembled into a battery module, the cells are often linked together through metal strips, straps, wires, bus bars, etc., that are welded, soldered, or otherwise fastened to each cell to link them together in the desired configuration.

A cell may be comprised of at least one positive electrode and at least one negative electrode. One common form of such a cell is the well-known secondary cells packaged in a cylindrical metal can or in a prismatic case. Examples of chemistry used in such secondary cells are lithium cobalt oxide, lithium manganese, lithium iron phosphate, nickel cadmium, nickel zinc, and nickel metal hydride. Other types of cells include capacitors, which can come in the form of electrolytic, tantalum, ceramic, magnetic, and include the family of super and ultra-capacitors. Such cells are mass produced, driven by an ever-increasing consumer market that demands low cost rechargeable energy storage.

Intermodal shipping is transportation using more than one mode of freight (e.g., truck and rail, rail and drone, ship and drone, or the like). The first mode may transport a number of containers from a first location to a second location. The second mode may transport a container from the number of containers from the second location to a third location. By utilizing two modes, a large number of containers may be brought to a distribution center and the containers may be dispersed from the regional distribution center to local distribution centers. For example, a ship may bring a large number of containers from one port to a second port. Then a train may transport a portion of the containers from the second port to a distribution center in the country of the second port. During intermodal shipping, a mode of transportation will often travel distinctly between a first location and a second location. Drones are beginning to be utilized for intermodal shipping.

### SUMMARY OF THE INVENTION

An intermodal shipping system is disclosed herein. The intermodal shipping system comprises a drone and a container. The drone may be configured to carry a load between 250 pounds and 2500 pounds. The drone comprises a drone battery. The container comprises a container battery. The container battery is configured to charge and/or extend the range of the drone battery during operation of the drone. The container battery is configured to charge while the container is idle (e.g., in transit, being loaded, or the like).

### BRIEF DESCRIPTION OF THE DRAWINGS

A more complete understanding of the present disclosure may be derived by referring to the detailed description and claims when considered in connection with the Figures, wherein like reference numbers refer to similar elements throughout the Figures, and where:

FIG. 1 illustrates an intermodal shipping system, in accordance with various embodiments;

FIG. 2 illustrates a container of an intermodal shipping system, in accordance with various embodiments;

FIG. 3 illustrates an intermodal shipping system, in accordance with various embodiments;

FIG. 4 illustrates a method of charging a drone for intermodal shipping, in accordance with various embodiments;

FIG. 5 illustrates a method of charging a drone for intermodal shipping, in accordance with various embodiments; and

FIG. 6 illustrates an intermodal shipping system, in accordance with various embodiments.

### DETAILED DESCRIPTION

The following description is of various example embodiments only, and is not intended to limit the scope, applicability or configuration of the present disclosure in any way. Rather, the following description is intended to provide a convenient illustration for implementing various embodiments including the best mode. As will become apparent, various changes may be made in the function and arrangement of the elements described in these embodiments, without departing from the scope of the appended claims. For example, the steps recited in any of the method or process descriptions may be executed in any order and are not necessarily limited to the order presented. Moreover, many of the manufacturing functions or steps may be outsourced to or performed by one or more third parties. Furthermore, any reference to singular includes plural embodiments, and any reference to more than one component or step may include a singular embodiment or step. Also, any reference to attached, fixed, connected or the like may include permanent, removable, temporary, partial, full and/or any other possible attachment option. As used herein, the terms “coupled,” “coupling,” or any other variation thereof, are intended to cover a physical connection, an electrical connection, a magnetic connection, an optical connection, a communicative connection, a functional connection, and/or any other connection.

For the sake of brevity, conventional techniques for mechanical system construction, management, operation, measurement, optimization, and/or control, as well as conventional techniques for mechanical power transfer, modulation, control, and/or use, may not be described in detail herein. Furthermore, the connecting lines shown in various figures contained herein are intended to represent example functional relationships and/or physical couplings between various elements. It should be noted that many alternative or additional functional relationships or physical connections may be present in a modular structure.

An intermodal shipping system is disclosed herein. The intermodal shipping system may comprise a drone and a container. The drone may comprise a drone battery configured to provide power to the drone. The container may comprise a container battery. The container battery may be configured to charge the drone battery and/or act as a range extender to the drone battery. In various embodiments, the container battery may be configured to charge during packing of the payload or while in transit (i.e., while the container is on the ground and being filled with a payload or during transit of a payload, the container battery may be charging to full capacity). The container battery may be coupled to the container, or the container battery may be integral to the container.

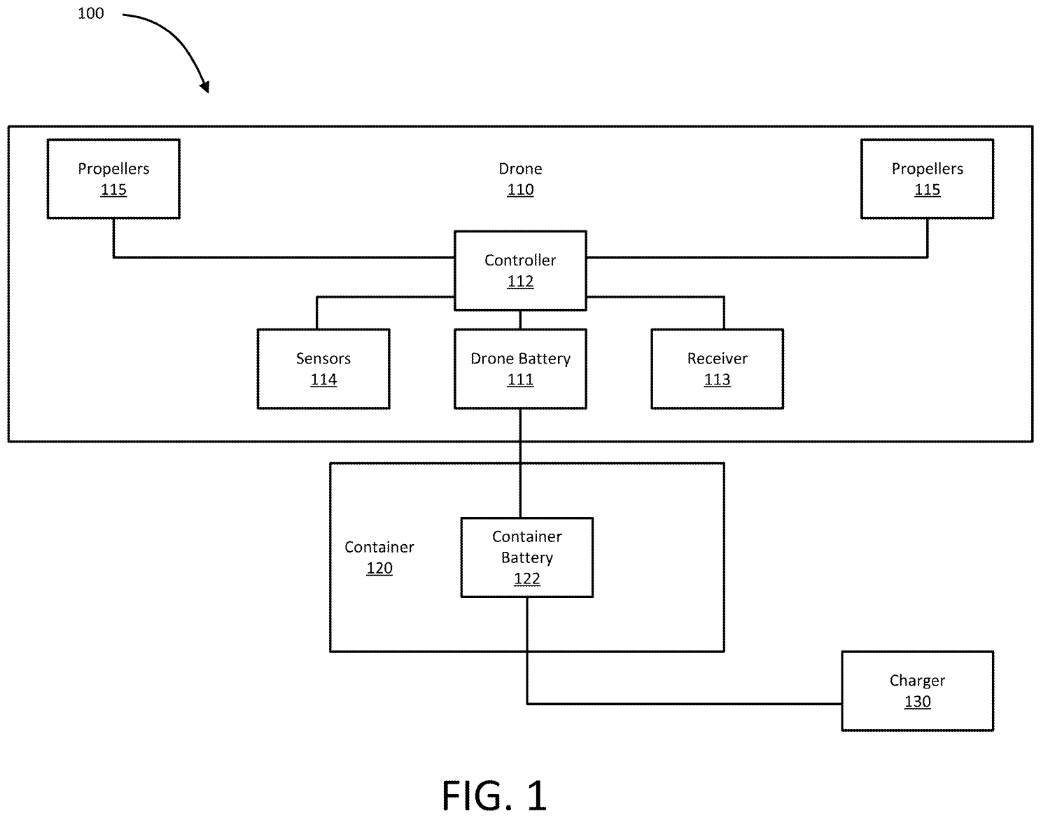

Referring now to FIG. 1, a schematic of an intermodal shipping system 100, in accordance with various embodiments, is illustrated. The intermodal shipping system 100 comprises a drone 110 (e.g., an intermodal drone), and a container 120 (e.g., a shipping container). In various embodiments, the drone 110 is configured for intermodal shipping. For example, drone 110 may be configured to carry a container 120 with a payload. In various embodiments, the combined weight of the payload and the container 120 may be a maximum gross weight between 250 pounds and 2500 pounds, or between 500 pounds and 2000 pounds, or the like. For example, container 120 filled to full capacity, may weigh between 250 pounds and 2500 pounds, or between 500 pounds and 2000 pounds. In various embodiments, the drone 110 comprises a drone battery 111. The drone battery 111 may comprise a lithium-ion battery, a lithium polymer battery, a nickel cadmium battery, or the like. In various embodiments, drone battery 111 comprises a power type battery (e.g., a lithium type A battery or the like). Drone 110 is configured to fly, pickup container 120 from a first location, transport container 120 to a second location, and drop off container 120 at the second location. Drone 110 may be any type of drone known in the art, such as a multirotor drone, a fixed wing drone, a single rotor drone, a fixed wing hybrid drone, or the like.

In various embodiments, the drone 110 further comprises a controller 112, a receiver 113, sensors 114, and propellers 115. The drone battery 111 may be in electrical communication with, and provide power to, the controller 112, the receiver 113, the sensors 114, and the propellers 115. In various embodiments, the controller 112 is configured to communicate with, provide operational instructions to, and receive instructions from, the receiver 113, the sensors 114, and the propellers 115.

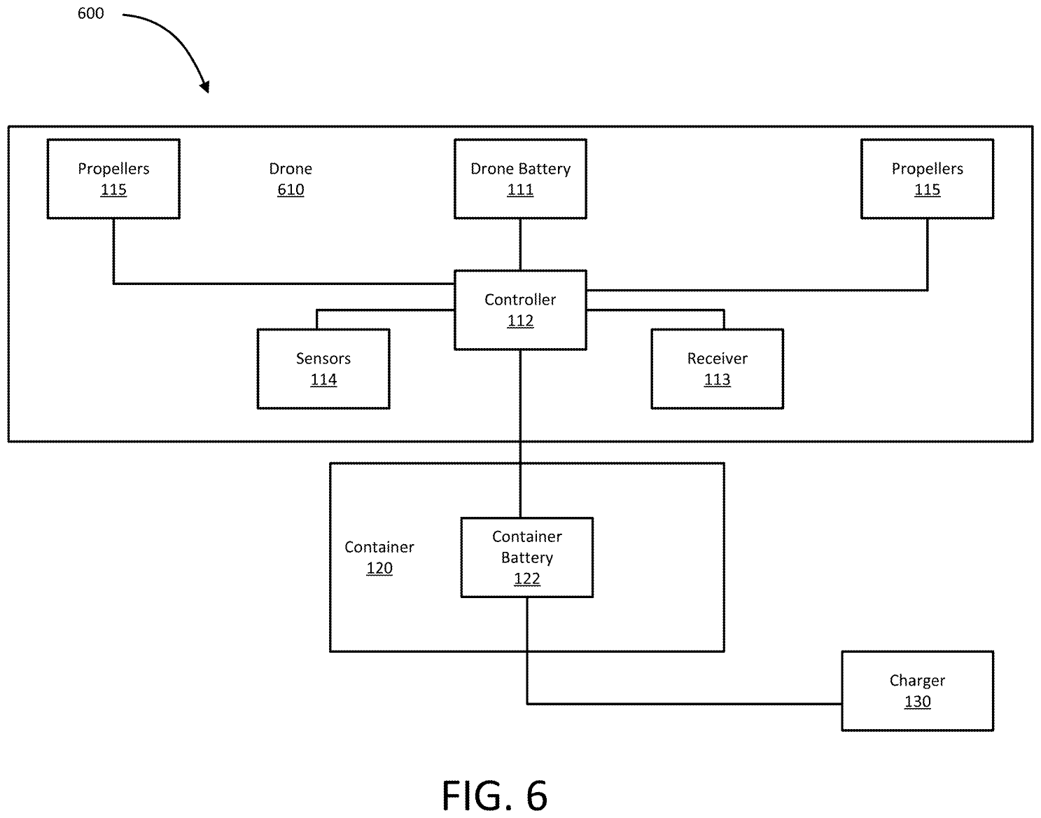

In various embodiments, during operation of drone 110, the container battery 122 may be in electrical communication with controller 112 and in electrical communication with drone battery 111 (e.g., connected in parallel). As such, container battery 122 may be configured to provide emergency power through controller 112 to propellers 115, sensors 114, and/or receiver 113. The container battery 122 may be configured to assist providing power during takeoff and landing (i.e., when greater power may be beneficial). In other example embodiments, the container battery 122 is connected in series with the drone battery 111. Although illustrated as being coupled directly to drone battery 111 in FIG. 1, the intermodal shipping system is not limited in the regard. For example, as shown in FIG. 6, an intermodal shipping system 600 where the drone battery 111 is indirectly coupled to the container battery 122 through the controller 112 is within the scope of this disclosure.

In various embodiments, container 120 is a shipping container assembly configured for intermodal shipping. Container 120 may be configured to attach to drone 110 by any method known in the art, such as by straps, fasteners, clamps, or the like. Container 120 comprises a container battery 122. In various embodiments, container battery 122 is configured to charge drone battery 111 and/or extend the range of drone 110 during operation of drone 110.

The container battery 122 may be configured to charge slowly relative to other batteries (e.g., drone battery 111) and/or provide a moderate discharge relative to other batteries (e.g., drone battery 111). For example, container battery 122 may have a charge rate between 0.2 C and 5 C, or between 0.2 C and 3 C, or between 0.2 C and 1 C. In various embodiments, container battery 122 is a polymer battery, a cobalt oxide battery, a lithium metal battery, a lithium silicon battery, a lithium sulfur battery, or the like. In various embodiments, the container battery 122 is a lithium metal battery.

In various example embodiments, the charge rates of the drone battery 111 and the container battery 122 may be the same, or one may be higher than the other. In particular, in various embodiments, it is advantageous that the container will typically have a longer time window available for charging without slowing down delivery schedules. In one embodiment, the drone battery is only charged during flight, and does not require charging when it makes drop offs and pick-ups. Typically, in various embodiments, this affords more time for charging the drone battery from the container battery.

In various embodiments, drone battery 111 may have a higher charge rate than container battery 122. For example, drone battery 111 may have a charge rate between 5 C and 30 C, or between 7 C and 25 C, or between 10 C and 20 C. In various embodiments, drone battery 111 may have the same charge rate as container battery 122. In various embodiments, by having a slower charging battery from the container battery 122, the battery may have a greater battery lifespan relative to drone battery 111. In various embodiments, the longer time to charge will not be a disadvantage of the container battery, since the container 120 would otherwise be idle during packing and/or storage.

In various embodiments, container battery 122 is configured to electrically couple to drone battery 111 by any method known in the art. For example, container battery 122 may be manually coupled to drone battery via a connector and receptacle. In various embodiments, container battery 122 and drone battery 111 may form an electrical connection upon attachment of the container 120 to the drone 110. For example, container battery 122 and drone battery 111 may create a snap fit upon coupling the container 120 to the drone 110. Any other electrical interface commonly known in the art is within the scope of this disclosure.

In various embodiments, intermodal shipping system 100 further comprises a charger 130. In various embodiments, charger 130 is a power source configured to charge container battery 122 by any method known in the art. In various embodiments, charger 130 may be coupled to an electrical outlet or the like and provide current and voltage to container battery 122, charging container battery 122. In various embodiments, charger 130 is wireless. In various embodiments, charger 130 is configured to charge container battery 122 while container 120 is being loaded and/or while container 120 is being transported (i.e., by boat, train, or the like). Charger 130 may be sized to charge fully in the time used to load container 120. In doing so, the container battery 122 may charge at a slower rate than drone battery 111. This may provide greater flexibility in optimizing drone battery 111 for continuous use with little to no charging of drone battery 111 at drop off and pick up of container 120.

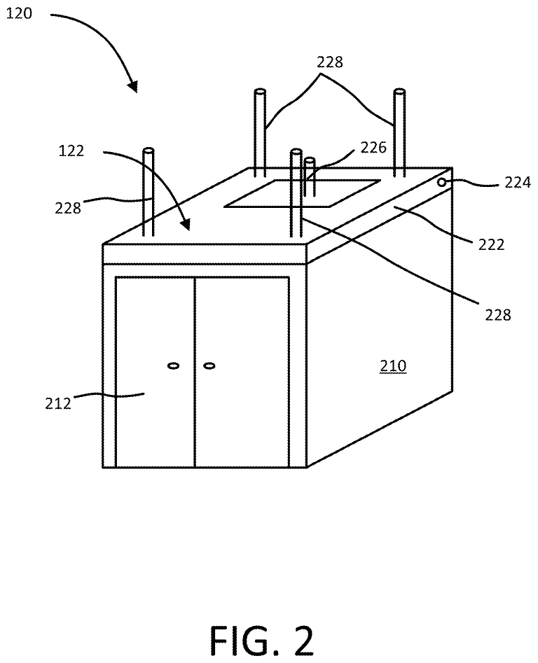

Referring now to FIG. 2, a container 120, in accordance with various embodiments, is illustrated. Container 120 comprises an enclosure 210 and a container battery 122. In various embodiments, container battery 122 is coupled to enclosure 210 by any method known in the art (i.e., a fastener, an adhesive, or the like). In various embodiments (not shown), enclosure 210 and container battery 122 are integral (e.g., a monolithic component). In various embodiments, container battery 122 comprises a battery module 222 and a charging port 224. In various embodiments, charging port 224 is electrically coupled to battery module 222. Charging port 224 may be configured to receive a charger (i.e., charger 130 from FIG. 1). In various embodiments, charging port 224 is configured to charge battery module 222 by any method known in the art.

In various embodiments, container battery 122 further comprises a charger 226. Charger 226 may be configured to charge a drone battery (e.g., drone battery 111 from FIG. 1) from container battery 122. The charger 226 may be configured to be electrically coupled to a respective charging port of the drone battery. Although illustrated as an external feature, charger 226 may be integrated with battery module 222. In an example embodiment, charger 226 may be configured to wirelessly communicate with the drone battery during operation of the drone (e.g., drone 110 from FIG. 1), charger 226 may further comprise a receptacle that receives a connector from drone battery 111. In another example embodiment, charger 226 comprises electrical contacts that are configured to contact electrical contacts of drone battery 111 during operation of drone 110 when the container is connected to the drone. Any electrical connection between drone battery 111 and container battery 122 is within the scope of this disclosure.

In various embodiments, container 120 further comprises alignment feature(s) 228. The alignment feature(s) 228 may ensure that the charger 226 creates an electrical connection with a respective charging port of a drone (e.g. drone 110 from FIG. 1 or drone 610 of FIG. 6). In various embodiments, alignment feature(s) 228 are coupled to the battery module 222. In various embodiments, the alignment feature(s) 228 are coupled to the enclosure 210. In various embodiments, the alignment feature(s) 228 are integral to the enclosure 210. In various embodiments, a respective drone 110 may have corresponding alignment feature(s) to receive alignment feature(s) 228. Alignment feature(s) 228 may be any alignment feature known in the art, such as a pin and respective receptacle, a hook and loop fastener, a snap fit feature, a guide pin, or the like. In various embodiments, the alignment feature(s) 228 may comprise low insertion force electrical contacts configured to electrically couple container battery 122 to drone battery 111, controller 112, and/or propellers 115 from FIG. 1. The system may be configured such that the electrical connection is made simultaneously with the physical connection of the container to the drone.

In various embodiments, enclosure 210 may comprise any material known in the art. For example, enclosure 210 may comprise steel, aluminum, fiber-reinforced polymer, plastic, composites, or the like. In various embodiments, enclosure 210 further comprises a gate 212. Gate 212 may allow access to an inside of enclosure 210. In various embodiments, gate 212 may open allowing individuals to load container 120 with items or products to be shipped. In various embodiments, container 120 may be configured to be loaded into a standard shipping container (e.g., a standard 20 foot shipping container, a standard 40 foot shipping container, a standard 20 foot high cube shipping container, a standard 40 foot high cube shipping container, or the like).

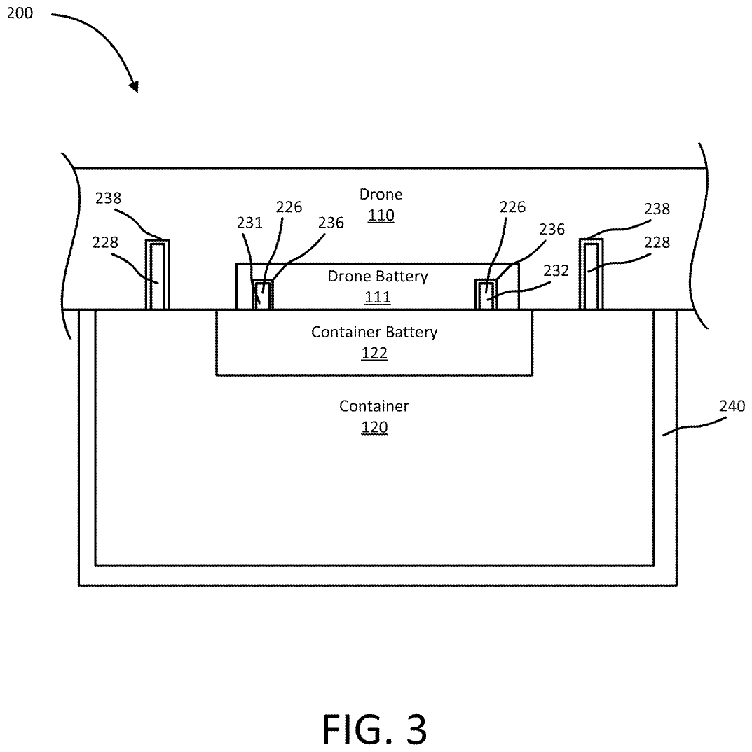

Referring now to FIG. 3, a schematic of an intermodal shipping system 200, in accordance with various embodiments, is illustrated. In various embodiments, drone battery 111 comprises charger receptacle(s) 236 configured to receive charger 226. In various embodiments, charger 226 comprises a positive terminal 231 and a negative terminal 232. The charger 226 of container battery 122 may create an electrical connection with drone battery 111 via charger receptacle(s) 236. The electrical connection may be created by manually adjusting the coupling of container 120 to drone 110, by manually plugging a connector into a receptacle, automatically coupling the container 120 to drone 110, or the like. In various embodiments (not shown), the charger may be disposed on drone battery 111 and the charger receptacles may be disposed on container battery 122. Any electrical connection between drone battery 111 and container battery 122 where the container battery 122 at least one of charges or extends the range of drone battery 111 is within the scope of this disclosure.

In various embodiments, alignment feature(s) 228 of container 120 may be disposed in corresponding alignment feature(s) 238 of drone 110. The alignment feature(s) 228, 238, may be configured to ensure an electrical connection between container battery 122 and drone battery 111. The intermodal shipping system 200 may further comprise an attachment feature 240 configured to couple the container 120 to the drone 110. The attachment feature 240 may be any attachment feature known in the art, such as a strap, a clamp, a hook and loop fastener, a snap fit fastener, or the like.

In various embodiments, drone battery 111 may be smaller and/or lighter than container battery 122. Drone battery 111 may be configured to at least provide enough power to fly between a first container battery (e.g., a container being dropped off) and a second container battery (e.g., a container being picked up). Drone battery 111 may further be configured to provide enough additional power for an emergency landing. By utilizing a container battery 122 in the intermodal shipping system 100, a smaller, more light weight drone battery 111 may be utilized compared to typical drone batteries. In various embodiments, drone battery 111 may only charge while in operation, as opposed to charging on ground and reducing efficiency.

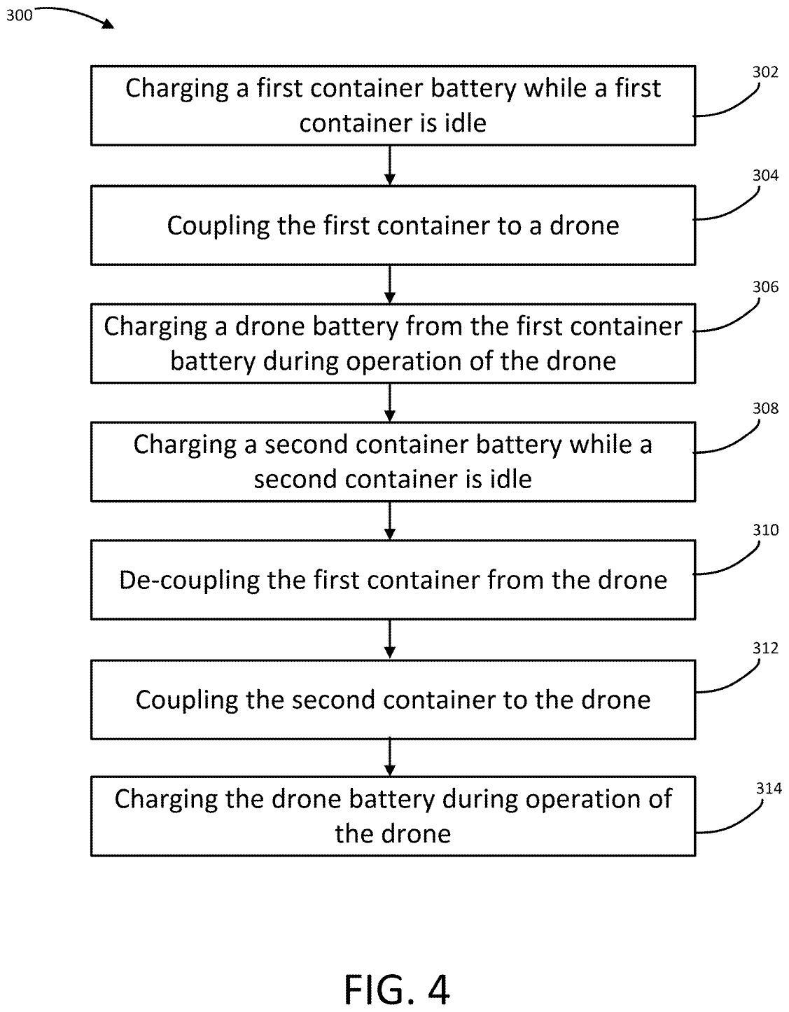

Referring now to FIG. 4, a method 300 of charging a drone for intermodal shipping, in accordance with various embodiments, is illustrated. The method comprises charging a first container battery while a first container is idle (step 302) (e.g., not in-flight, not connected to the drone). For example, a charging port of a first container battery may be charged while a first container is being loaded, while the first container is being shipped, or the like. The first container battery may be loaded to full capacity.

The method 300 further comprises coupling the first container to a drone (step 304). The drone may be configured for intermodal shipping and/or configured to carry a load weighing between 250 pounds and 2500 pounds, or between 500 pounds and 2000 pounds. The drone may comprise a drone battery. In coupling the first container to the drone, the drone battery may be electrically coupled to a charger of the container battery.

The method 300 further comprises charging the drone battery during operation of the drone (step 306). In various embodiments, the container battery may act as a range extender to the drone battery. The method 300 may further comprise charging a second container battery while a second container is idle (step 308). The second container may be idle in a similar manner as the first container was idle. In various embodiments, the second container is disposed in a location that is a destination of the drone carrying the first container.

The method 300 may further comprise de-coupling the first container from the drone (step 310). The de-coupling may further include electrically decoupling the drone battery from the first container battery of the first container. The method may further comprise coupling the second container to the drone (step 312). By coupling the second container to the drone, a container battery disposed on the second container may be electrically coupled to the drone battery. As such, the method may further comprise charging the drone battery during operation of the drone (step 314). In various embodiments, step 314 may be replaced with extending the range of a drone battery during operation of the drone. In various embodiments, the method may be repeated with additional containers and container batteries.

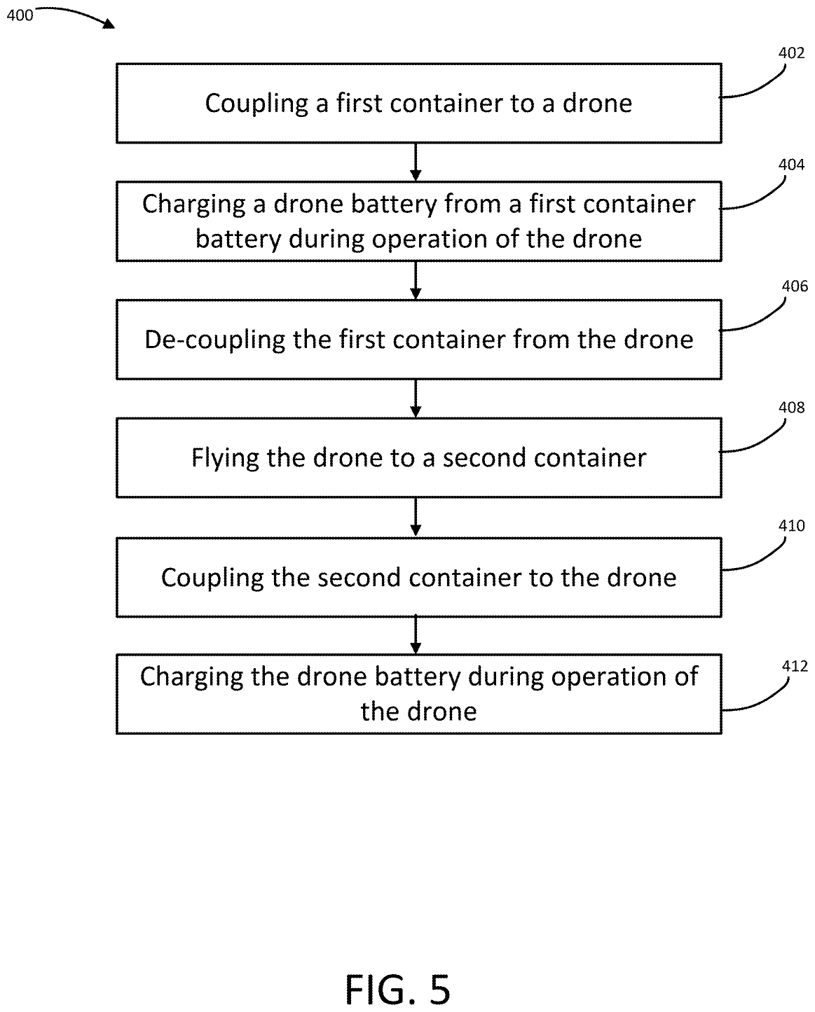

Referring now to FIG. 5, a method 400 of charging a drone for intermodal shipping, in accordance with various embodiments, is illustrated. The method 400 further comprises coupling the first container to a drone (step 402). The drone may be configured for intermodal shipping and/or configured to carry a load weighing between 250 pounds and 2500 pounds, or between 500 pounds and 2000 pounds. The drone may comprise a drone battery. In coupling the first container to the drone, a drone battery may be electrically coupled to a charger of the container battery.

The method 400 further comprises charging the drone battery during operation of the drone (step 404). In various embodiments, the container battery may act as a range extender to the drone battery. The method 400 may further comprise de-coupling the first container from the drone (step 406). For example, the first container may be dropped off at a drop off location and de-coupled from the drone. The de-coupling may further include electrically decoupling the drone battery from the first container battery of the first container.

The method 400 may further comprise flying the drone from the first container to a second container (step 408). For example, at the drop off location of the first drone, it may be beneficial to have a pick up location for a second container. The method 400 may further comprise coupling the second container to the drone (step 410). By coupling the second container to the drone, a container battery disposed on the second container may be electrically coupled to the drone battery. As such, the method may further comprise charging the drone battery during operation of the drone (step 412). In various embodiments, step 412 may be replaced with extending the range of a drone battery during operation of the drone. In various embodiments, the method may be repeated with additional containers and container batteries traveling between drop off and pick up locations of various containers.

In various embodiments, the methods 300,400 may allow a quick turn-around from a drone dropping a first container off and picking up a second container. For example, in one embodiment, a quick turn-around means that there is not time added to the time between landing and taking off that is required by charging of batteries. In another example embodiment, a quick turn-around means that the time between take off and landing can be limited by no more than the time to disconnect a first container and to connect to a second container or the time to unload and load the connected container. In various embodiments, the intermodal shipping systems 100, 200, 600 may allow for near continuous operation of drone 110 with little to no on-ground charging of drone battery 111. This may allow for an efficient intermodal shipping system between regional and local distribution centers or the like. Additionally, drone battery 111 may have greater battery life in the intermodal shipping systems 100, 200, 600 as drone battery 111 may charge at its optimal rate as opposed to a more aggressive rate on ground due to desired efficiency of the system, in accordance with various embodiments. Also, container battery 122 may be more cost effective, as it is able to charge at a slower rate, since loading time can take a long duration, in accordance with various embodiments.

A method is disclosed herein. The method may comprise: coupling a first container to a drone, the first container comprising a first container battery, the drone comprising a drone battery, the first container battery being electrically coupled to the drone battery; charging the drone battery with the first container battery during operation of the drone; de-coupling the first container from the drone; flying the drone to a second container; and coupling a second container to the drone, the second container comprising a second container battery, the second container battery being electrically coupled to the drone battery.

While the principles of this disclosure have been shown in various embodiments, many modifications of structure, arrangements, proportions, elements, materials and components (which are particularly adapted for a specific environment and operating requirements) may be used without departing from the principles and scope of this disclosure. These and other changes or modifications are intended to be included within the scope of the present disclosure and may be expressed in the following claims.

The present disclosure has been described with reference to various embodiments. However, one of ordinary skill in the art appreciates that various modifications and changes can be made without departing from the scope of the present disclosure. Accordingly, the specification is to be regarded in an illustrative rather than a restrictive sense, and all such modifications are intended to be included within the scope of the present disclosure. Likewise, benefits, other advantages, and solutions to problems have been described above with regard to various embodiments.

However, benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

When language similar to “at least one of A, B, or C” or “at least one of A, B, and C” is used in the claims or specification, the phrase is intended to mean any of the following: (1) at least one of A; (2) at least one of B; (3) at least one of C; (4) at least one of A and at least one of B; (5) at least one of B and at least one of C; (6) at least one of A and at least one of C; or (7) at least one of A, at least one of B, and at least one of C.

We claim:

1. A container for use in intermodal shipping, the container comprising:
an enclosure for containing goods for shipment, the container configured to be coupled to, and carried by, a drone;
a container battery coupled to the enclosure, the container battery comprising:
a charging port configured to charge the container battery; and
a charger configured to charge a drone battery, wherein:
the container battery comprises a first charge rate between 0.2 and 1 C, and
the container battery is configured to charge the drone battery, via the charger, the drone battery comprising a second charge rate between 10 and 20 C.

2. The container of claim 1, wherein the charger is configured to be electrically coupled to the drone battery when the container is connected to the drone.

3. The container of claim 1, further comprising at least one alignment feature configured to align the charger with a respective drone battery charging port.

4. The container of claim 1, wherein the container battery comprises a lithium metal battery.

5. An intermodal shipping system, comprising:
a drone having a drone battery, the drone battery comprising a first charge rate between 10 and 20 C; and
a container comprising a container battery configured to charge the drone battery during operation of the drone, the container battery comprising a second charge rate between 0.2 and 1 C.

6. The intermodal shipping system of claim 5, wherein the container further comprises an enclosure coupled to the container battery.

7. The intermodal shipping system of claim 5, wherein the drone is configured to carry a load weighing between 500 pounds and 2,500 pounds.

8. The intermodal shipping system of claim 5, wherein the container battery further comprises a charger configured to be electrically coupled to a respective drone charging port of the drone battery.

9. The intermodal shipping system of claim 8, wherein the container battery further comprises a charging port configured to charge the container battery.

10. The intermodal shipping system of claim 5, wherein:
the drone further comprises a controller and a propeller, and
the controller is in electrical communication with the drone battery.

11. The intermodal shipping system of claim 10, wherein the controller is in electrical communication with the container battery when the container is coupled to the drone.

12. The intermodal shipping system of claim 11, wherein the controller is operable to provide power from the container battery to the propeller when the drone battery is low on power.

13. The intermodal shipping system of claim 10, wherein the controller is operable to:
receive an indication that the drone battery is low on power, and
switch a power source of the drone from the drone battery to the container battery.

14. A method of charging a drone for intermodal shipping, the method comprising:
charging a first container battery at a first charge rate at a first location between 0.2 and 1 C while a first container is one of being loaded or being transported, the first container comprising the first container battery;
coupling the first container to the drone, the drone comprising a drone battery; and
charging the drone battery at a second charge rate between 10 and 20 C with the first container battery during operation of the drone.

15. The method of claim 14, further comprising charging a second container battery while a second container is idle.

16. The method of claim 15, further comprising:
de-coupling the first container from the drone;
coupling the second container to the drone; and
charging the drone battery during operation of the drone with the second container battery.

17. The method of claim 14, wherein the first container battery further comprises a charging port configured to charge the first container battery.

18. The method of claim 14, further comprising powering the drone with the first container battery.

19. The method of claim 18, wherein powering the drone with the first container battery is in response to the drone battery being low on power.
